(19) United States
(12) Patent Application Publication
(10) Pub. No.: US 2026/0214355 A1
(43) Pub. Date: Jul. 23, 2026

(54) SOLID-STATE IMAGING DEVICE

(71) Applicant: Sony Semiconductor Solutions Corporation, Kanagawa (JP)

(72) Inventor: Yoshitaka Miyatani, Tokyo (JP)

(21) Appl. No.: 19/136,029

(22) PCT Filed: Dec. 27, 2023
(86) PCT No.: PCT/JP23/47039

§ 371 Date: Jun. 5, 2025

(30) Foreign Application Priority Data
Jan. 11, 2023 (JP) 2023-002728

(51) Int. Cl. H04N 25/707; H04N 25/47; H04N 25/702

(52) U.S. Cl. CPC H04N 25/707; H04N 25/47; H04N 25/702

(57) ABSTRACT

Event detection pixels with distortion correction are disclosed. In one example, a solid-state imaging device includes an optical system, a first pixel, a second pixel, a pixel array, and a signal processing circuit. The first pixel obtains image information based on luminance information via the optical system. The second pixel obtains event detection information based on a change in the luminance information via the optical system. The pixel array includes the first pixels and the second pixels in a two-dimensional array. The signal processing circuit selects whether or not to perform distortion correction on the event detection information obtained by the second pixel and performs signal processing.

### TECHNICAL FIELD

The present disclosure relates to a solid-state imaging device.

### BACKGROUND ART

With improvement of a semiconductor technology of a camera module, the camera module has been developed at a significant speed in height reduction and angle widening. In addition, a pixel for event detection can be arranged in a pixel array in a hybrid manner in addition to a pixel for obtaining color information such as RGB information, and the event detection and the obtainment of the color information can be implemented in parallel on the same coordinate axis.

However, there is no discussion about distortion correction for sensors that can obtain two different data types in the camera module. That is, the distortion correction is performed on an image of the color information such as RGB, but the distortion correction is not performed on output from the event detection pixel. For this reason, there is a possibility that a point representing the same coordinate is different in position between the event detection pixel and the pixel for obtaining the color information.

### CITATION LIST

### Patent Document

Patent Document 1: Japanese Translation of PCT International Application Publication No. 2022-521093

### SUMMARY OF THE INVENTION

### Problems to be Solved by the Invention

Therefore, one of non-limiting problems to be solved by embodiments of the present disclosure is to correct distortion of an event detection pixel. The problem to be solved by the embodiments of the present disclosure can also be a problem corresponding to effects described in the embodiments as some further non-limiting examples. That is, the problem corresponding to at least arbitrary one of the effects described in the description of the embodiments of the present disclosure can be the problem to be solved in the present disclosure.

### Solutions to Problems

According to one embodiment, a solid-state imaging device includes an optical system, a first pixel, a second pixel, one or a plurality of pixel arrays, and a signal processing circuit.

The first pixel obtains image information based on luminance information via the optical system.

The second pixel obtains event detection information based on a change in the luminance information via the optical system.

The one or plurality of pixel arrays includes the first pixels and the second pixels in a two-dimensional array.

The signal processing circuit selects whether or not to perform distortion correction on the event detection information obtained by the second pixel and performs signal processing.

The one or plurality of pixel arrays may include one pixel array, and

the second pixels may be arranged at a predetermined ratio with respect to the first pixels in a predetermined region in the pixel array.

The predetermined region may include an entire region of the pixel array.

The second pixels may be arranged at equal intervals so as to cover an entire region of the predetermined region.

The second pixel may detect an event for each frame.

The second pixel may detect an event by an arbiter method.

The signal processing circuit may perform distortion correction on the image information.

The signal processing circuit may
convert resolution of the event detection information into resolution of the image information, and
perform distortion correction on the converted event detection information.

The signal processing circuit may
perform the distortion correction on the event detection information based on a difference between resolution of the event detection information and resolution of the image information.

The signal processing circuit may
set a region of interest on the basis of the image information, and
obtain the event detection information corresponding to the region of interest.

The signal processing circuit may
perform tracking on the basis of the event detection information subjected to the distortion correction corresponding to the region of interest.

The signal processing circuit may
compare a value obtained by performing the distortion correction on the event detection information with a threshold for coordinates after performing the distortion correction on the event detection information, and obtain event detection information at the coordinates after performing the distortion correction.

The signal processing circuit may
store the event detection information at the coordinates after performing the distortion correction as 1.5 bit information.

The one or plurality of pixel arrays may include:
a first pixel array in which the first pixels are arranged in a two-dimensional array; and
a second pixel array in which the second pixels are arranged in a two-dimensional array and which obtains the event detection information of the same target as a target of the first pixel array.

The optical system may include:
a first optical system that condenses light on the first pixel array; and
a second optical system that condenses light on the second pixel array.

The signal processing circuit may include:
a first signal processing circuit that performs signal processing on output from the first pixel; and
a second signal processing circuit that performs signal processing on output from the second pixel.

The signal processing circuit may
perform image processing on the basis of the image information subjected to the distortion correction and the event detection information subjected to the distortion correction.

The signal processing circuit may
perform deblurring processing on the basis of the image information subjected to the distortion correction and the event detection information subjected to the distortion correction.

The signal processing circuit may
perform high frame rate processing on the basis of the image information subjected to the distortion correction and the event detection information subjected to the distortion correction.

The signal processing circuit may
perform tracking processing on the basis of the image information subjected to the distortion correction and the event detection information subjected to the distortion correction.

### BRIEF DESCRIPTION OF DRAWINGS

FIG. 1 is a block diagram schematically illustrating a solid-state imaging device according to one embodiment.

FIG. 2 is a block diagram schematically illustrating an imaging section according to the one embodiment.

FIG. 3 is a diagram illustrating an example of arrangement of pixels in a pixel array according to the one embodiment.

FIG. 4 is a block diagram schematically illustrating the imaging section according to the one embodiment.

FIG. 5 is a diagram illustrating an example of data transition according to the one embodiment.

FIG. 6 is a flowchart illustrating processing by a solid-state imaging device according to one embodiment.

FIG. 7 is a flowchart illustrating the processing by the solid-state imaging device according to the one embodiment.

FIG. 8 is a flowchart illustrating processing by a solid-state imaging device according to one embodiment.

FIG. 9 is a diagram illustrating an example of setting a region of interest according to the one embodiment.

FIG. 10 is a flowchart illustrating the processing by the solid-state imaging device according to the one embodiment.

FIG. 11 is a block diagram schematically illustrating a solid-state imaging device according to one embodiment.

FIG. 12 is a diagram schematically illustrating a substrate of a solid-state imaging device according to one embodiment.

FIG. 13 is a diagram schematically illustrating the substrate of the solid-state imaging device according to the one embodiment.

FIG. 14 is a diagram schematically illustrating the substrate of the solid-state imaging device according to the one embodiment.

FIG. 15 is a block diagram illustrating an example of a schematic configuration of a vehicle control system.

FIG. 16 is an explanatory diagram illustrating an example of installation positions of an outside-vehicle information detecting section and the imaging section.

### MODE FOR CARRYING OUT THE INVENTION

The following is a description of embodiments of the present disclosure, with reference to the drawings. The drawings are used for the description, and a shape and a size of a configuration of each component in an actual device, a ratio of the size to another component, and the like are not necessarily as illustrated in the drawings. In addition, since the drawings are illustrated in a simplified manner, configurations necessary for implementation other than those illustrated in the drawings are assumed to be appropriately provided.

### First Embodiment

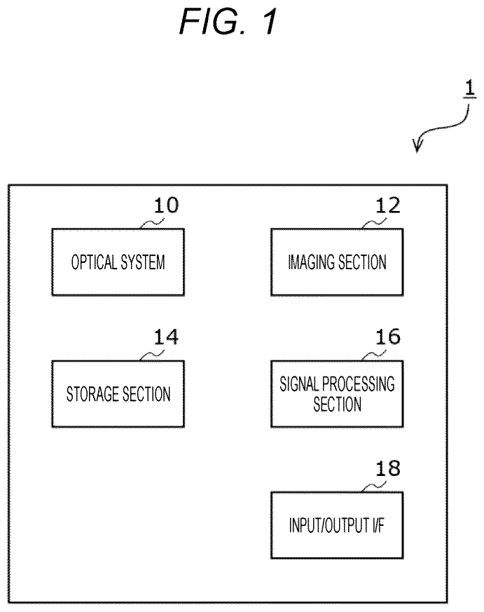

FIG. 1 is a block diagram schematically illustrating a solid-state imaging device according to one embodiment. A solid-state imaging device 1 includes an optical system 10, an imaging section 12, a storage section 14, a signal processing section 16, and an input/output interface (hereinafter, it is referred to as an input/output I/F 18). The solid-state imaging device 1 is a device that includes at least a first pixel that obtains image information from luminance information and a second pixel that obtains event detection information from a change in the luminance information, obtains the image information, and also obtains the event detection information in the image.

The optical system 10 is an optical system that appropriately condenses light on the imaging section 12.

The imaging section 12 includes the first pixel and the second pixel, and obtains the image information and the event detection information. For example, the imaging section 12 obtains information about a region including the same target in the first pixel and the second pixel.

The storage section 14 stores data obtained by the imaging section 12, or data being processed or data processed by the signal processing section 16. The storage section 14 may include, for example, a storage circuit that temporarily or non-temporarily stores data, such as various kinds of memories, various kinds of storages, or the like. At least a part of the storage section 14 may be provided outside the solid-state imaging device 1.

The signal processing section 16 performs various kinds of processing on the data obtained by the imaging section 12, and outputs the data. This processing can include, for example, processing of converting an analog signal output from a pixel circuit into a digital signal, processing of obtaining a pixel value from the digital signal, processing of performing image processing, and the like. Incidentally, at least a part of the processing described above may be performed in a pixel circuit of the imaging section 12.

The signal processing section 16 may include a dedicated processing circuit such as an application specific integrated circuit (ASIC) or the like, a general-purpose processing circuit such as a central processing unit (CPU) or the like, or a programmable circuit such as a field programmable gate array (FPGA) or the like in at least a part thereof. In a case where at least a part of the signal processing section 16 includes a general-purpose circuit, the processing performed by the at least a part of the signal processing section 16 may be in a form in which information processing by software is specifically implemented by using a hardware resource. In this case, a program, an execution file, or the like related to the software is stored in the storage section 14, and the general-purpose circuit of the signal processing section 16 can obtain the program or the like stored in the storage section 14 to implement the information processing.

The input/output I/F 18 is an interface that connects the inside and the outside of the solid-state imaging device 1. The solid-state imaging device 1 can receive control by a user directly or indirectly from the input/output I/F 18. In addition, the solid-state imaging device 1 can implement transmission and reception of data with the inside and the outside via the input/output I/F 18.

In addition to the configurations described above, the solid-state imaging device 1 appropriately includes, for example, a control section for controlling each component of the solid-state imaging device 1, a power supply section for supplying power to each component, and the like as necessary.

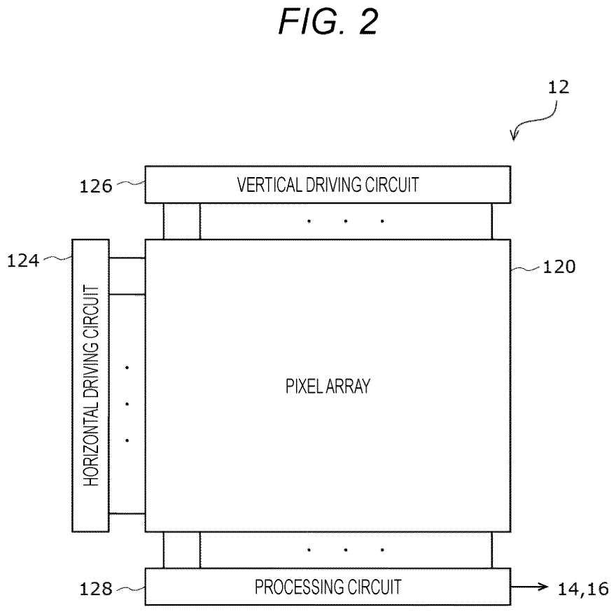

FIG. 2 is a diagram schematically illustrating a non-limiting example of the imaging section 12. As an example, the imaging section 12 includes a pixel array 120, a horizontal driving circuit 124, a vertical driving circuit 126, and a processing circuit 128. The imaging section 12 appropriately processes and outputs signals obtained by pixels arranged in the pixel array 120.

The pixel array 120 is formed by arranging the pixels in a two-dimensional array. The pixel array 120 includes the first pixel that obtains the luminance information and the second pixel that obtains the change in the luminance information.

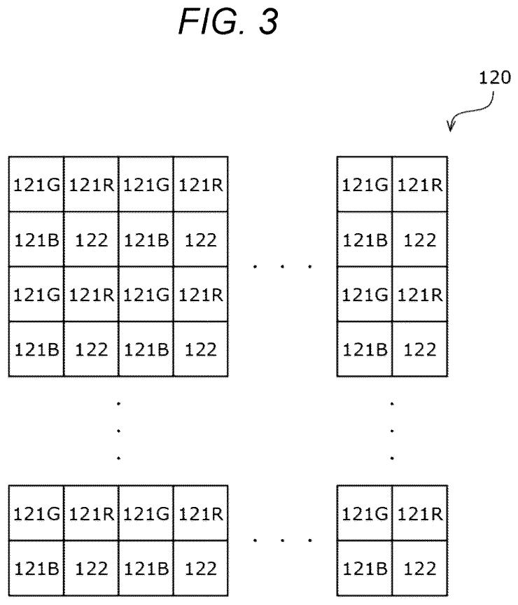

FIG. 3 is a diagram illustrating an example of the arrangement of the pixels in the pixel array 120. The pixel array 120 is formed by, for example, periodically arranging first pixels 121 and second pixels 122.

The first pixels 121 may include light receiving elements that obtain the luminance information, and each of the light receiving elements may be configured as a pixel that obtains any one of colors of RGB. The color may be selected by a color filter included in the light receiving element, or the light receiving element may include an organic photoelectric conversion film or the like.

The second pixels 122 include light receiving elements that obtain the change in the luminance information as the event detection information.

As illustrated in FIG. 3, first pixels 121R, 121G, and 121B and the second pixel 122 may form a pixel group as one group, and the first pixels 121 that obtain signals representing the colors of RGB and the second pixels 122 that obtain signals representing the event information may be periodically arranged with respect to the same coordinates in an image coordinate system.

These light receiving elements may be in a form formed as divided pixels including divided light receiving elements in the same pixel, that is, in a form formed by setting a group of a first divided pixel for obtaining the luminance information and a second divided pixel for obtaining the change in the luminance information as one pixel.

Incidentally, the arrangement of the pixels is not limited to the arrangement in this figure, and for example, a first pixel 121W that obtains light representing white may be included, or first pixels 121Mg, 121Cy, 121Ye, and the like that represent light representing complementary colors may be included. In addition, the group of the first pixels 121 and the second pixels 122 may include another number of pixels such as 2×3 pixels, 3×3 pixels, or the like instead of 2×2 pixels. That is, the group of the pixels may be in a form in which the second pixels 122 are appropriately arranged at a predetermined ratio with respect to the first pixels 121.

In addition, in FIG. 3, the second pixels 122 are arranged at a predetermined ratio over an entire region of the pixel array 120, but the form of the present disclosure is not limited thereto. For example, the second pixel 122 may be in a form arranged in a predetermined region of the pixel array 120. For example, in a case where it is desired to obtain movement of a target in the predetermined region, a form may be adopted in which the second pixel 122 is included in the predetermined region in an image region, and the second pixel 122 is not arranged in the other region of the pixel array 120.

Returning to FIG. 2, the horizontal driving circuit 124 and the vertical driving circuit 126 select and drive the first pixel 121 and the second pixel 122 in the pixel array 120, and transmit signals from the driven pixels to the processing circuit 128. For example, in a line selected by the horizontal driving circuit 124, the vertical driving circuit 126 drives the pixels in a column, so that the signals from the selected and driven pixels are transmitted to the processing circuit 128.

The processing circuit 128 performs appropriate processing on the received signals, and outputs the signals to the storage section 14 or the signal processing section 16. Incidentally, the processing circuit 128 may be formed as a part of the signal processing section 16 instead of the imaging section 12. For example, in a case where the signals output from the pixel array 120 are analog signals, and an analog to digital converter (ADC) that converts the analog signals into digital signals is included as the processing circuit 128, the ADC may be included as a part of the imaging section 12 or may be included as a part of the signal processing section 16.

Although only one horizontal driving circuit 124 is illustrated, each of a horizontal driving circuit that selects the first pixel 121 and a horizontal driving circuit that selects the second pixel 122 may be included. Similarly for the vertical driving circuit 126, each of a vertical driving circuit that selects a column of the first pixel 121 and a vertical driving circuit that selects a column of the second pixel 122 may be included.

Similarly for the processing circuit 128, each of a processing circuit that receives and processes the signal from the first pixel 121 and a processing circuit that receives and processes the signal from the second pixel 122 may be included.

In this manner, the imaging section 12 can obtain the image information and the event detection information by driving the first pixel 121 and the second pixel 122 forming the pixel array 120 by the processing for each frame. That is, the imaging section 12 can obtain the image information and the event detection information as frame images.

On the other hand, a form may be adopted in which the signal from the first pixel 121 is obtained for each frame, and the signal from the second pixel 122 is obtained at a timing when an event is detected.

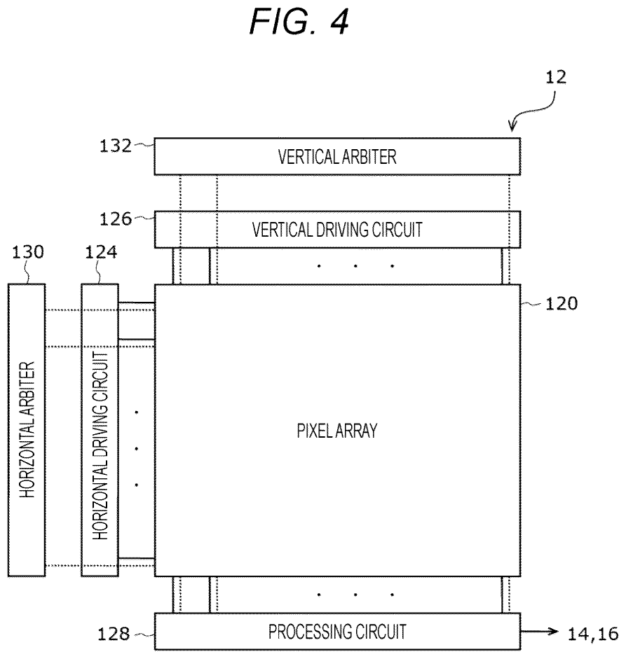

FIG. 4 is a block diagram schematically illustrating another example of the imaging section according to the one embodiment. As illustrated in FIG. 4, output from the second pixel 122 may be processed by a horizontal arbiter 130 and a vertical arbiter 132. As examples of a path followed by the signal from the second pixel 122, paths represented by dotted lines are illustrated.

In this manner, the form may be adopted in which the imaging section 12 can process the signal from the first pixel 121 as the frame image, and obtain the output from the second pixel 122 at the timing when the event is detected in the second pixel 122.

The image information and the event detection information output from the imaging section 12 in the form of FIG. 2 or FIG. 4 are processed by the signal processing section 16. In general, an aberration caused by an optical system 100 occurs in light obtained via the optical system 100. As an aberration that can occur as a large error as an image, there is a distortion aberration. In the present disclosure, correction of the distortion aberration will be described, but similar processing can be performed for processing that enables position correction by so-called image and signal processing also for other aberrations.

The signal processing section 16 performs signal processing for correcting a distortion aberration of the image information obtained from the first pixel 121. In addition, the signal processing section 16 may selectively perform signal processing for correcting a distortion aberration of the event detection information obtained from the second pixel 122 in a manner similar to that of the correction of the image information obtained from the first pixel 121. This selection may be setting in which distortion correction of the event detection information is always performed, or may be setting in which on/off switching can be performed by a user. In addition, a form may be adopted in which the solid-state imaging device 1 determines a condition and determine whether or not to perform the distortion correction on the event detection information.

The processing of the signal processing section 16 will be described in detail.

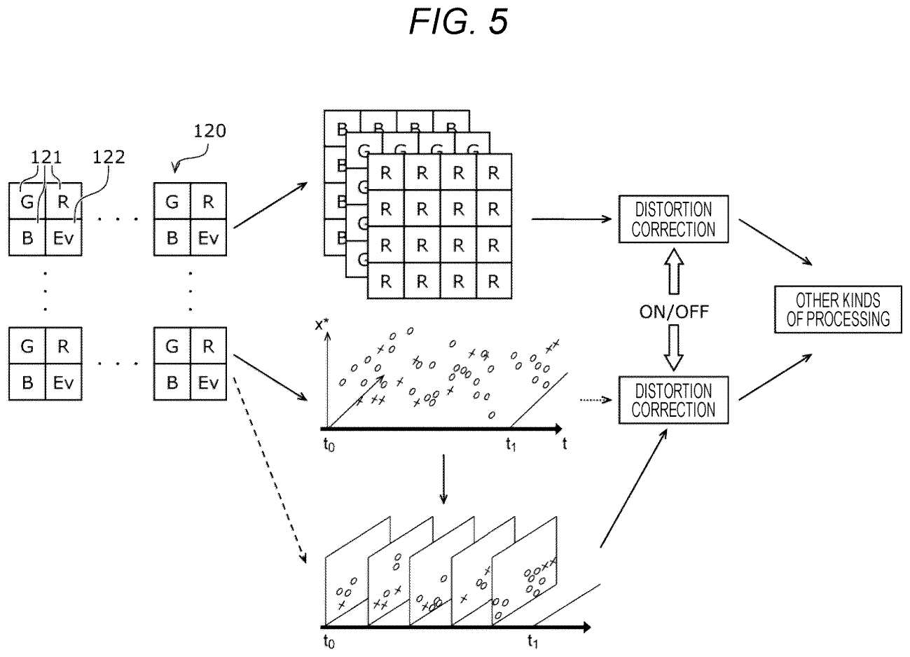

FIG. 5 is a diagram schematically illustrating a series of flow from light reception to data processing in the solid-state imaging device 1. The solid-state imaging device 1 performs processing related to the image information and processing related to the event detection information on the basis of the signals output from the first pixel 121 and the second pixel 122 included in the pixel array 120, respectively.

The signal processing section 16 (a part of the processing thereof may be implemented by the imaging section 12) can, for example, convert an analog signal obtained by the first pixel 121 into a digital signal, and interpolate a defect at a position of the second pixel 122. Thereafter, the signal processing section 16 obtains pieces of the image information for the respective colors by performing demosaic processing, color matrix processing, and the like. As necessary, the signal processing section 16 performs distortion correction on these pieces of image information.

On the other hand, the signal processing section 16 processes the signal output from the second pixel 122 in parallel. In the figure, o represents event information in a positive direction, and x indicates event information in a negative direction.

In a case where the output of the second pixel 122 is obtained by an arbiter method, the signal processing section 16 may perform conversion into data (event grid) in a frame format at the same timing as a frame for obtaining the image information via the first pixel 121. In a case where the output of the second pixel 122 is obtained by a frame method as represented by a broken line arrow, the signal processing section 16 can set data obtained for each frame as the event detection information (event grid).

In addition, as represented by a dotted line arrow, the signal processing section 16 may process, at the next stage, coordinate information about a signal for determining whether the event is in the positive direction or the negative direction in the event detection information obtained by the arbiter method, without generating the event grid.

The signal processing section 16 performs distortion correction on the event detection information of the frame method or the event detection information of the arbiter method as necessary.

The signal processing section 16 can implement the distortion correction on the image information or the event detection information on the basis of the following expressions, for example.

$$\begin{matrix}[ Mathematical Expression 1 ] & \\ \begin{matrix}{x}_{2} = {x}_{1} ( 1 + {k}_{1} {r}^{2} + {k}_{2} {r}^{4} ) + 2 {p}_{1} {x}_{1} {y}_{1} + {p}_{2} ( {r}^{2} + 2 {x}_{1}^{2} ) & ( 1 ) \\ {y}_{2} = {y}_{1} ( 1 + {k}_{1} {r}^{2} + {k}_{2} {r}^{4} ) + 2 {p}_{2} {x}_{1} {y}_{1} + {p}_{2} ( {r}^{2} + 2 {y}_{1}^{2} ) & ( 2 ) \\ r = \sqrt{{x}_{1}^{2} + {y}_{1}^{2}} & ( 3 )\end{matrix} & \end{matrix}$$

Here, (x₁, y₁) is image coordinates after the distortion correction, and (x₂, y₂) is image coordinates before the distortion correction. The (x₁, y₁) may further be coordinates in a coordinate system converted from world coordinates into camera coordinates using external parameters, and then converted into image coordinates using internal parameters. Distortion coefficients of a lens in a radial direction are represented by k₁ and k₂, and distortion coefficients of the lens in a circumferential direction are represented by p₁ and p₂. Incidentally, distortion may be barrel-type distortion, bobbin-type distortion, or distortion obtained by combining these.

Thereafter, the signal processing section 16 performs the appropriate signal processing using the image information subjected to the distortion correction or not subjected to the distortion correction and the event detection information subjected to the distortion correction or not subjected to the distortion correction. This signal processing may be processing using, for example, a spiking neural network (SNN). The processing is not limited to the processing using the SNN, and the signal processing section 16 can perform appropriate processing on the image information using the event detection information subjected to the distortion correction as necessary.

As described above, according to the present embodiment, the solid-state imaging device 1 can implement the signal processing including the distortion correction of the event detection information obtained as necessary. By performing the distortion correction on the event detection information, it is possible to implement the signal processing and the image processing to which the event detection information using the same coordinate system is added in the coordinate information in the image information.

### Second Embodiment

In the embodiment described above, the overall flow of the solid-state imaging device 1 has been described. In a second embodiment, distortion processing of obtained event detection information will be described in detail.

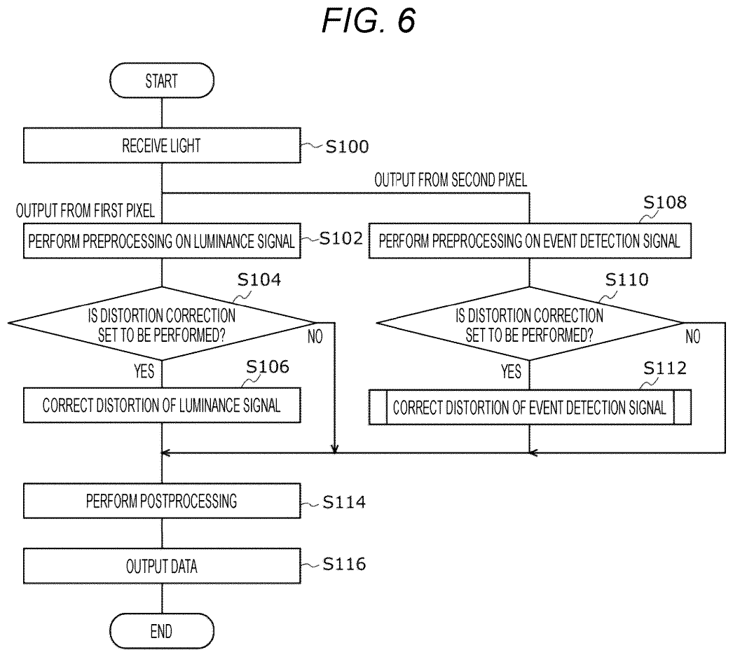

FIG. 6 is a flowchart illustrating processing by a solid-state imaging device 1 according to the one embodiment. This flowchart illustrates a flow in a case where a float operation (floating point operation) is possible in processing of event detection information. In addition, the following flowcharts can also cope with a case where the processing can be performed by a fixed point.

The solid-state imaging device 1 obtains information about reflected light, transmitted light, or emitted light from various kinds of targets in an imaging region in an imaging section 12 by a first pixel 121 and a second pixel 122 in a pixel array 120 (S100).

A signal processing section 16 appropriately preprocesses the obtained output from the first pixel 121 (S102). As described above, the preprocessing may include conversion from an analog signal to a digital signal, defect correction, demosaic, color matrix processing, and the like. Incidentally, a form may be adopted in which a part of the processing is performed by the imaging section 12 to transmit processed data to the signal processing section 16.

The signal processing section 16 determines whether distortion correction is set to be performed or the distortion correction is not set to be performed as specified by a user or specified by the solid-state imaging device 1 (S104). The setting for the distortion correction may be specified by the user, or may be determined and specified by the solid-state imaging device 1 on the basis of information about a video signal or the like.

In a case where the distortion correction is set to be performed (S104: YES), the signal processing section 16 performs the distortion correction on an image obtained from luminance information by performing the distortion correction on the preprocessed image information (S106). The distortion correction is performed, for example, on the basis of Expressions (1) to (3) described above.

On the other hand, the signal processing is also performed for the event detection information. The signal processing section 16 appropriately preprocesses the obtained output from the second pixel 122 (S108). This preprocessing may include, for example, processing of converting information obtained in an arbiter format into an event grid for each frame.

The signal processing section 16 determines whether the distortion correction is set to be performed or the distortion correction is not set to be performed as specified by the user or specified by the solid-state imaging device 1 (S110). The setting for the distortion correction may be specified by the user, or may be determined and specified by the solid-state imaging device 1 on the basis of the information about the video signal or the like. In addition, in a case where the distortion correction is performed on the image information, the signal processing section 16 can be set to automatically perform the distortion correction on an event detection signal.

In a case where the distortion correction is set to be performed (S110: YES), the signal processing section 16 performs the distortion correction on the event detection information obtained from change information about luminance by performing the distortion correction on the preprocessed event detection signal (S112).

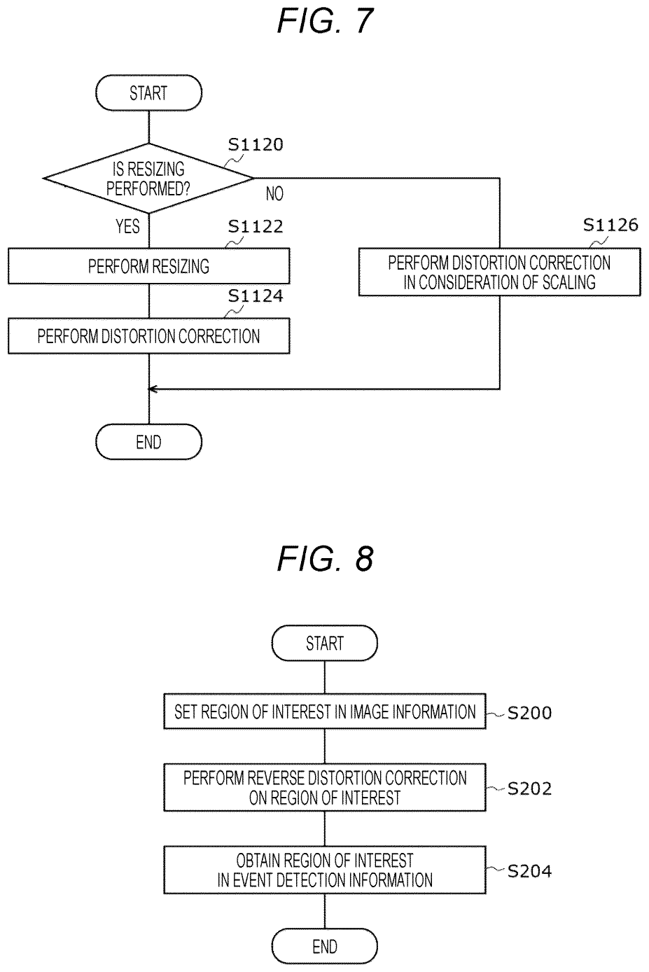

FIG. 7 is a flowchart illustrating an example of the processing in S112 described above according to the one embodiment.

The signal processing section 16 determines whether or not to resize the event detection information (S1120). The determination of resizing may be set in advance. In this case, according to the setting, processing of S1122 or processing of S1126 described below can be performed without performing the processing of S1120 by software implementation or hardware implementation.

In a case where the resizing is performed (S1120: YES), the signal processing section 16 performs processing of adjusting resolution of the data preprocessed as the event detection information so as to match coordinates in the image information. A general method can be used to convert the resolution. By this conversion of the resolution, the event detection information can be arranged on the same coordinate system as the image information at the same scale. The event detection information may use a floating point representation.

The signal processing section 16 performs the distortion correction on the event detection information in which the resolution is converted (S1124). The signal processing section 16 can perform this distortion correction in accordance with Expressions (1) to (3) having a coefficient common to that of the image information. In this case, the signal processing section 16 can obtain the event detection information subjected to the distortion correction in the same coordinate system as the image information by using the high-resolution event detection information.

In this manner, the signal processing section 16 can convert resolution of the event detection information into the resolution of the image information, and perform the distortion correction on the converted event detection information.

In a case where the resizing is not performed (S1120: NO), the signal processing section 16 performs the distortion correction in consideration of scaling for the event detection information (S1126). For example, the signal processing section 16 can set image coordinates before the distortion correction to (x′₂, y′₂) and apply Expressions (1) to (3) to coordinates (x₂, y₂) scaled by the following conversion expressions. Incidentally, the same distortion coefficient as that of the distortion correction of the image information described above can be similarly used.

$$\begin{matrix}[ Mathematical Expression 2 ] & \\ \begin{matrix}{x}_{2} = {Nx}_{2}^{′} & ( 4 ) \\ {y}_{2} = {Ny}_{2}^{′} & ( 5 )\end{matrix} & \end{matrix}$$

Also in this case, the event detection information may use the floating point representation.

In this manner, the signal processing section 16 can perform the distortion correction in consideration of the scaling based on a difference between the resolution of the event detection information and the resolution of the image information. For example, N in Expressions (4) and (5) can be determined on the basis of the predetermined ratio described above.

Returning to FIG. 6, after the distortion correction is performed or in a case where the distortion correction is not set to be performed (S104: NO, S110: NO), the signal processing section 16 can perform arbitrary postprocessing on the basis of the obtained image information and event detection information (S114). The postprocessing may be, for example, processing using the SNN or the like described above, processing using another learned model, or arbitrary processing not using a learned model.

In a case where both the image information and the event detection information are subjected to the distortion correction, the coordinates of the event detection information are matched with the coordinates of the image information on the basis of these pieces of information subjected the distortion correction, and then processing using various kinds of learned models such as SNN or the like, tracking processing, and the like can be implemented.

The signal processing section 16 can appropriately output the data after the postprocessing is performed (S116). This output may be a form in which outputting is performed to the outside of the solid-state imaging device 1 via an input/output I/F 18, or may be a form in which the data is stored in the storage section 14.

As described above, according to the present embodiment, it is possible to appropriately perform the distortion correction on the event detection information, and to perform the processing of performing more accurate matching with the coordinates of the image information.

### Third Embodiment

In the embodiment described above, the case has been described where the event detection information can be represented by the floating point, but in some cases, the event detection information may not be represented by the floating point. In addition, even in a case where the event detection information can be represented as the floating point, it may be desired to obtain only a flag of the event detection information in the subsequent processing. In such a case, there is a possibility that a problem such as temporal and arithmetic cost or the like occurs when an operation is performed using the floating point as in the second embodiment. In a third embodiment, implementation in which such a floating point operation can be omitted will be described.

A signal processing section 16 can set a region of interest on an image by, for example, processing such as object detection or the like in the signal processing section 16 or specification by a user. The signal processing section 16 can implement event detection for this region of interest.

FIG. 8 is a flowchart illustrating processing by a solid-state imaging device 1 according to the one embodiment.

The signal processing section 16 sets a region of interest in image information (S200). The signal processing section 16 may set a region specified by a user via an input/output I/F 18 as the region of interest. The signal processing section 16 may set a region including a target specified by the user via the input/output I/F 18 as the region of interest. In addition, the signal processing section 16 can also detect a target by arbitrary processing and set the region of interest on the basis of a result of the detection.

The signal processing section 16 can obtain a region of interest in a coordinate system of event detection information not subjected to distortion correction by performing reverse distortion correction on the region of interest in the image information (S202). Incidentally, at a timing of this reverse distortion correction, the signal processing section 16 can also perform conversion of coordinates in consideration of resizing and scaling described in the second embodiment described above, as necessary.

On the basis of a result thereof, the signal processing section 16 obtains the region of interest in the event detection information (S204).

In this manner, the solid-state imaging device 1 can also convert the region of interest in the image subjected to the distortion correction into the region of interest in the event detection information not subjected to the distortion correction.

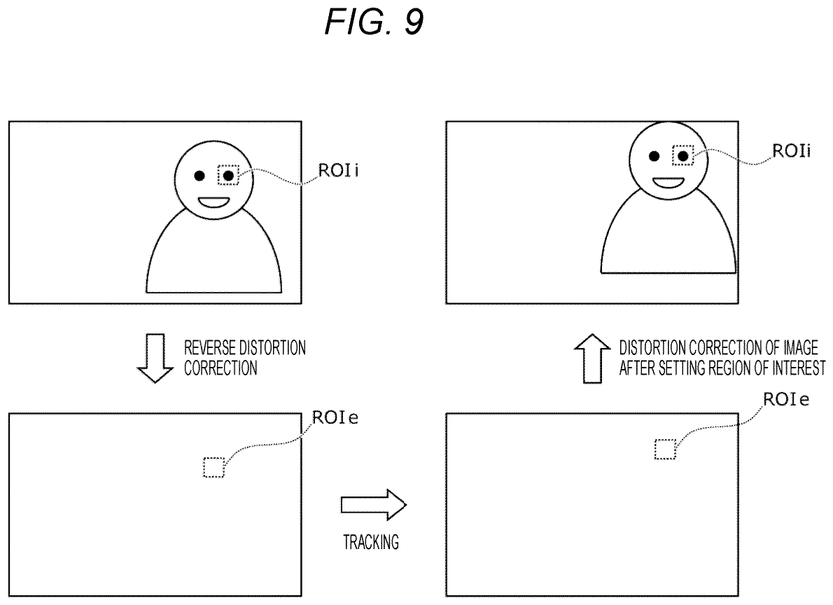

FIG. 9 is a diagram illustrating an example of setting the region of interest according to the one embodiment. For example, the solid-state imaging device 1 obtains, as the target, video information including a person or image information continuous in time series. The signal processing section 16 automatically extracts an eye region from the image subjected to the distortion correction, and sets a region of interest ROIi. As another example, a user may specify an arbitrary position in the image, and the signal processing section 16 may set the region of interest ROIi on the basis of the specification.

The signal processing section 16 can obtain information about a region of interest ROIe in a coordinate system in event detection information not subjected to the distortion correction by performing reverse distortion conversion on the region of interest ROIi. Incidentally, in the figure, the region of interest ROIe is indicated by a rectangle, but the shape is not limited thereto. In a case where there is distortion in a barrel type, a bobbin type, or a combination thereof, information about the region of interest ROIe according to a shape of the distortion can also be obtained.

By obtaining the region of interest ROIe and event information around the region of interest ROIe in the coordinate system of the event detection information (not subjected to the distortion correction), the signal processing section 16 can perform tracking of the target included in the region of interest ROIi set in the image.

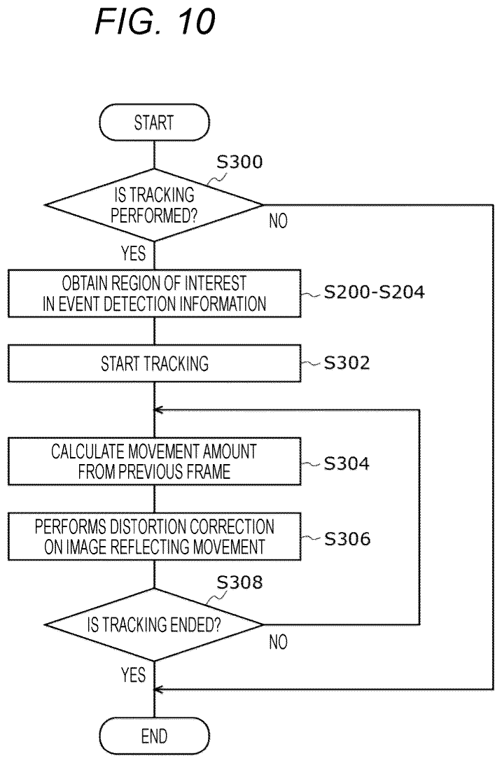

FIG. 10 is a flowchart illustrating an example of processing in the example of the tracking described above.

The signal processing section 16 determines whether or not to perform the tracking (S300). Presence or absence of the tracking may be specified by a user or may be automatically specified by the solid-state imaging device 1. In a case where tracking is not performed (S300: NO), the following processing does not need to be performed, and transition to a standby state for the determination in S300 may be performed.

In a case where the tracking is performed (S300: YES), the signal processing section 16 obtains the region of interest in coordinates of the event detection information not subjected to the distortion correction, by processing of S200 to S204 in FIG. 8.

The signal processing section 16 starts the tracking by using the event detection information (S302). In the following processing, the signal processing section 16 performs the tracking for the region of interest ROIe in FIG. 9, for example.

The signal processing section 16 detects the event information in and around the region of interest ROIe, and calculates a movement amount from a previous frame to a current frame from a change in luminance information in the region of interest ROIe (S304). For example, the signal processing section 16 performs the tracking of the region of interest ROIe from the event detection information at a lower left to the event detection information at a lower right in FIG. 9, and obtains the movement amount or coordinates (with distortion) of a movement destination.

For the image information before the distortion correction, the signal processing section 16 sets, as the region of interest, the same region (in a case where resizing and scaling are performed, the same region in consideration of the resizing and scaling) as the region of interest ROIe obtained from the event detection information, and performs the distortion correction on the image information including the region of interest to perform the tracking in the image (S306). As a result, the signal processing section 16 can obtain the region of interest ROIi in a coordinate system subjected to the distortion correction as illustrated in an upper right of FIG. 9.

The signal processing section 16 continues the processing of S304 and S306 until the tracking ends (S308: NO). The end of the tracking can be determined according to, for example, a condition in which imaging has ended, the user has commanded the end of the tracking, or the like.

As described above, it is possible to set the region of interest in the image information and implement the processing in the set region of interest without performing a floating point operation in the event detection information. For example, in the case of an arbiter format, the event detection information can be obtained faster than obtainment of the luminance information (image information), and a calculation cost can be lower than that of the luminance information. For this reason, it is possible to implement the processing related to the event detection such as the tracking or the like faster than the processing using the image information.

The solid-state imaging device 1 can perform, for example, the implementation described above in autofocus processing using eye tracking, or the like. That is, for example, the solid-state imaging device 1 may perform the eye tracking on the basis of the event detection information, and obtain an image in which an optical system is controlled so that a focus is on the region of interest obtained in the image information. In addition, the present disclosure is not limited thereto, and it is possible to implement processing for obtaining the event detection information faster and applying the event detection information to a frame of the image information.

### Fourth Embodiment

As described above, the processing after the event detection information is obtained may not correspond to the floating point operation, for example, using a result thereof as input of the SNN. In such a case, it is possible to use a form in which the data obtained after the distortion correction is not output using a floating point representation.

For example, a signal processing section 16 controls and outputs a result not to be a floating point after distortion correction. As an example, after the distortion correction, the signal processing section 16 may select nearest (x, y) coordinates as coordinates of event detection information, obtain a value after conversion of the event detection information at the coordinates (x, y), and compare the obtained value with a threshold to obtain an event detection result at the coordinates (x, y).

The signal processing section 16 may determine that a positive event has occurred when a value of event detection at the coordinates (x, y) after the distortion correction is a predetermined positive threshold or more, may determine that a negative event has occurred when the value is a predetermined negative threshold or less, and may determine that no event has occurred otherwise.

The signal processing section 16 can also output this result as a 1.5 bit result.

As described above, the signal processing section 16 can convert the result obtained as the floating point into 1.5 bit data and output the 1.5 bit data. By performing the conversion into such data, when the output data is used, the output data can be used as it is.

### Fifth Embodiment

In each of the embodiments described above, the form including the hybrid pixels in which the first pixel 121 and the second pixel 122 are arranged in the same pixel array 120. The embodiments in the present disclosure are not limited thereto, and may be in a form of so-called sensor fusion.

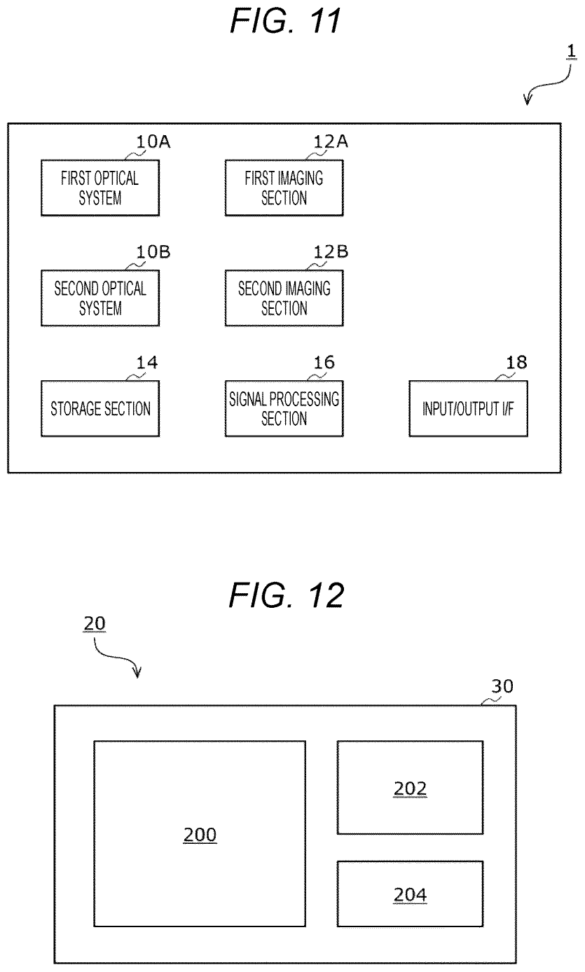

FIG. 11 is a block diagram schematically illustrating a solid-state imaging device according to one embodiment. A solid-state imaging device 1 includes a first optical system 10A and a second optical system 10B as optical systems, and a first imaging section 12A and a second imaging section 12B as imaging sections.

The first imaging section 12A includes a first pixel array in which first pixels 121 for obtaining luminance information are arranged in a two-dimensional array. The first optical system 10A is set such that light is condensed on the first pixel array.

The second imaging section 12B includes a second pixel array in which second pixels 121 for obtaining change information about luminance are arranged in a two-dimensional array. The second optical system 10B is set such that light is condensed on the second pixel array.

For example, a signal processing section 16 can perform processing of adapting event detection information obtained in the second pixel array to image information obtained in the first pixel array. With this processing, the signal processing section 16 can implement processing in which coordinates of the event detection information is caused to match coordinates of the image information before distortion correction or after distortion correction.

In this manner, also in the form of sensor fusion, it is possible to implement the processing similar to that of the solid-state imaging device 1 described above. According to this form, even in an existing device that includes two imaging systems and performs event detection and image obtainment, it is possible to implement the distortion correction on the event detection information by changing the processing of the signal processing section 16.

Incidentally, the solid-state imaging device 1 is not limited to the form of FIG. 11. For example, the solid-state imaging device 1 may have a form having one optical system for the first imaging section 12A and the second imaging section 12B.

In these cases, a distortion coefficient may be set for each pixel array as necessary.

In addition, the solid-state imaging device 1 may have a form including, for example, a first signal processing section that processes a signal from the first imaging section 12A and a second signal processing section that processes a signal from the second imaging section 12B. In this case, a form may be adopted in which the first signal processing section and the second signal processing section can share data as necessary.

In any case, each imaging section may be formed on another semiconductor chip, or may be formed on the same semiconductor chip.

### Sixth Embodiment

In each of the embodiments described above, for example, the form in which the tracking is performed has been described, but the present disclosure is not limited thereto. A solid-state imaging device 1 can implement, for example, deblurring processing, optical flow processing, motion blur removal processing, and the like on the basis of image information subjected to distortion correction and event detection information subjected to the distortion correction.

In addition, as a matter of course, it is possible to implement the tracking processing described as an example for a region of interest in the embodiments described above.

In addition to the blur correction and tracking processing described above, the solid-state imaging device 1 can perform arbitrary image processing on the image information by using the event detection information subjected to the distortion correction. As another non-limiting example, the solid-state imaging device 1 can also implement a high frame rate or the like of the image information using the event detection information subjected to the distortion correction.

FIG. 12 is an implementation example of a chip 20 in the solid-state imaging device 1. The chip 20 includes a pixel array region 200, a storage circuit region 202, and a processing circuit region 204 on the same semiconductor substrate 30. In this manner, the pixel array region 200, the storage circuit region 202, and the processing circuit region 204 may be provided on the one semiconductor substrate 30. Each component is connected by an appropriate conductive wire or the like.

The pixel array region 200 is a region in which a pixel array 120 is arranged. The storage circuit region 202 is a region in which at least a part of a storage section 14 is arranged. The processing circuit region 204 is a region in which at least a signal processing section 16 is arranged.

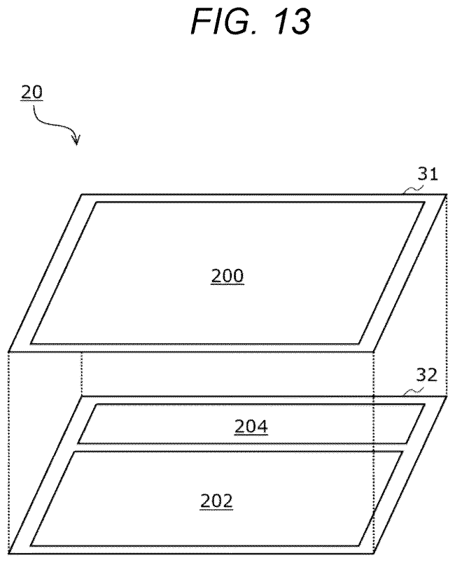

FIG. 13 is another implementation example different from the above. The chip 20 may be implemented on a first semiconductor layer 31 and a second semiconductor layer 32 which are different semiconductor layers. The first semiconductor layer 31 is provided with the pixel array region 200, and the second semiconductor layer 32 is provided with the storage circuit region 202 and the processing circuit region 204. The first semiconductor layer 31 and the second semiconductor layer 32 are stacked, formed as an integrated semiconductor device, and operate. For example, the first semiconductor layer 31 is arranged closer to an optical system 100 than the second semiconductor layer 32, light via the optical system 100 is received by the first semiconductor layer 31, and a signal is output to the second semiconductor layer 32.

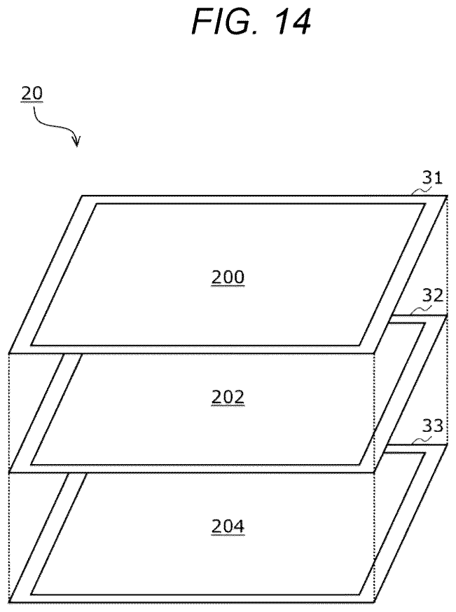

FIG. 14 is another implementation example different from the above. The chip 20 may be implemented on the first semiconductor layer 31, the second semiconductor layer 32, and a third semiconductor layer 33, which are different semiconductor layers. The first semiconductor layer 31 is provided with the pixel array region 200, the second semiconductor layer 32 is provided with the storage circuit region 202, and the third semiconductor layer 33 is provided with the processing circuit region 204. The first semiconductor layer 31, the second semiconductor layer 32, and the third semiconductor layer 33 are stacked, formed as an integrated semiconductor device, and operate. For example, the first semiconductor layer 31 is arranged closest to the optical system 100, light via the optical system 100 is received by the first semiconductor layer 31, and a signal is output to at least one of the second semiconductor layer 32 or the third semiconductor layer 33.

In the case of the forms illustrated in FIGS. 3 and 4, for example, a chip on chip (CoC) method may be adopted in which the semiconductor layers are cut out from a wafer, divided into individual pieces, and then stacked and bonded to each other vertically. In addition, a chip on wafer (CoW) method may be adopted in which any one layer is cut out and divided into individual pieces, and then bonded to a wafer. Alternatively, a wafer on wafer (WoW) method may be adopted in which pieces of wear are bonded to each other and then divided into individual pieces.

For bonding the semiconductor layers, a via hole, a microbump, a micropad, plasma bonding, or the like can be used as a non-limiting example. By such a method, the respective semiconductor layers are appropriately electrically connected and formed so as to be able to transmit and receive signals.

The technology according to the present disclosure can be applied to various products. For example, the technology according to the present disclosure may also be implemented as a device included in any type of mobile body such as an automobile, an electric automobile, a hybrid electric automobile, a motorcycle, a bicycle, a personal mobility, an airplane, a drone, a ship, a robot, a construction machine, an agricultural machine (tractor), or the like.

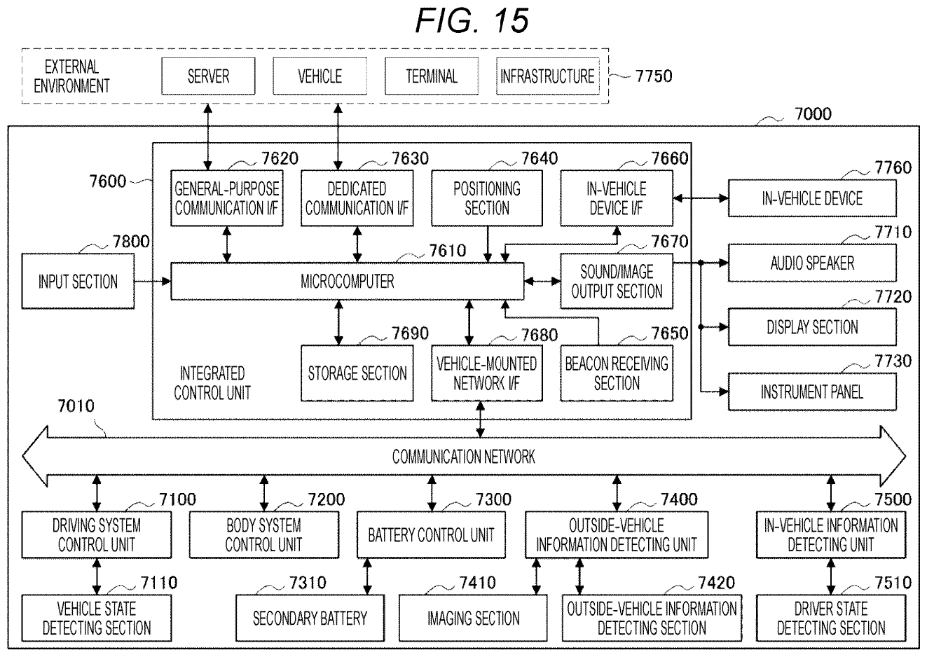

FIG. 15 is a block diagram illustrating a schematic configuration example of a vehicle control system 7000 as an example of a mobile body control system to which the technology according to the present disclosure can be applied. The vehicle control system 7000 includes a plurality of electronic control units connected to each other via a communication network 7010. In the example illustrated in FIG. 15, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. In FIG. 15, a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690 are illustrated as functional configurations of the integrated control unit 7600. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

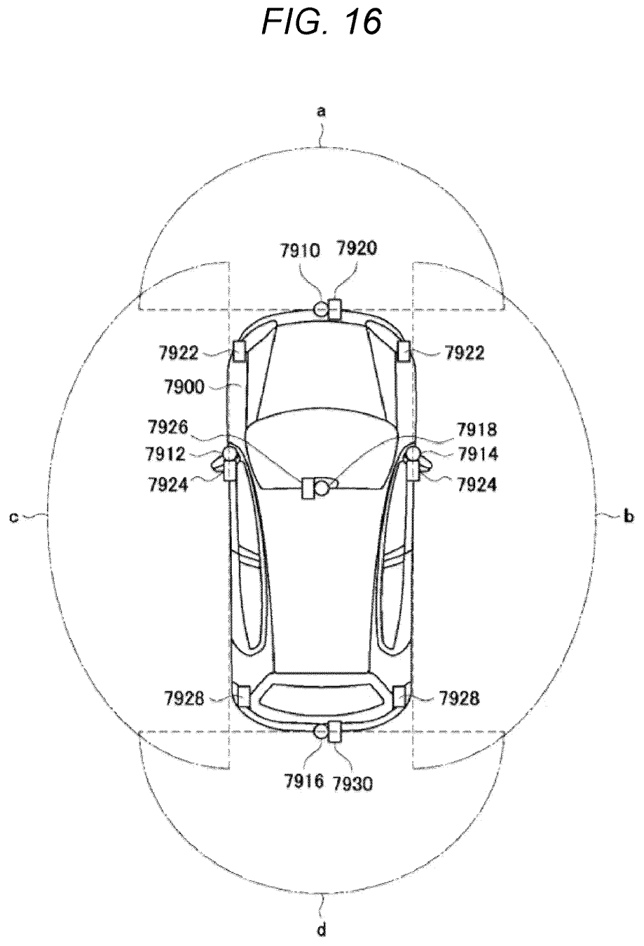

Here, FIG. 16 illustrates an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 16 illustrates an example of an imaging range of each of the imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Referring back to FIG. 15, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 15, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, in the example illustrated in FIG. 15, at least two control units connected via the communication network 7010 may be integrated as one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Incidentally, a computer program for implementing each function of the solid-state imaging device 1 according to the present embodiments described with reference to FIGS. 1 to 14, particularly the signal processing section 16, can be implemented on any control unit or the like. In addition, a computer-readable recording medium in which such a computer program is stored can also be provided. The recording medium is, for example, a magnetic disk, an optical disk, a magneto-optical disk, a flash memory, or the like. In addition, the computer program described above may be distributed via, for example, a network without using the recording medium.

The embodiments described above may have the following forms.

(1)

A solid-state imaging device including:
an optical system;
a first pixel that obtains image information based on luminance information via the optical system;
a second pixel that obtains event detection information based on a change in the luminance information via the optical system;
one or a plurality of pixel arrays in which the first pixels and the second pixels are provided in a two-dimensional array; and
a signal processing circuit that selects whether or not to perform distortion correction on the event detection information obtained by the second pixel and performs signal processing.
   (2)

The solid-state imaging device according to (1), in which
the one or plurality of pixel arrays includes one pixel array, and
the second pixels are arranged at a predetermined ratio with respect to the first pixels in a predetermined region in the pixel array.
   (3)

The solid-state imaging device according to (2), in which
the predetermined region includes an entire region of the pixel array.
   (4)

The solid-state imaging device according to (2) or (3), in which
the second pixels are arranged at equal intervals so as to cover an entire region of the predetermined region.
   (5)

The solid-state imaging device according to any one of (1) to (4), in which
the second pixel detects an event for each frame.
   (6)

The solid-state imaging device according to any one of (1) to (4), in which
the second pixel detects an event by an arbiter method.
   (7)

The solid-state imaging device according to any one of (1) to (6), in which
the signal processing circuit performs distortion correction on the image information.
   (8)

The solid-state imaging device according to (7), in which
the signal processing circuit
converts resolution of the event detection information into resolution of the image information, and
performs distortion correction on the converted event detection information.
   (9)

The solid-state imaging device according to (7), in which
the signal processing circuit
performs the distortion correction on the event detection information based on a difference between resolution of the event detection information and resolution of the image information.
   (10)

The solid-state imaging device according to any one of (1) to (9), in which
the signal processing circuit
sets a region of interest on the basis of the image information, and
obtains the event detection information corresponding to the region of interest.
   (11)

The solid-state imaging device according to (10), in which
the signal processing circuit
performs tracking on the basis of the event detection information subjected to the distortion correction corresponding to the region of interest.
   (12)

The solid-state imaging device according to any one of (1) to (11), in which
the signal processing circuit
compares a value obtained by performing the distortion correction on the event detection information with a threshold for coordinates after performing the distortion correction on the event detection information, and obtains event detection information at the coordinates after performing the distortion correction.
   (13)

The solid-state imaging device according to (12), in which
the signal processing circuit
stores the event detection information at the coordinates after performing the distortion correction as 1.5 bit information.
   (14)

The solid-state imaging device according to (1), in which
the one or plurality of pixel arrays includes:
a first pixel array in which the first pixels are arranged in a two-dimensional array; and
a second pixel array in which the second pixels are arranged in a two-dimensional array and which obtains the event detection information of the same target as a target of the first pixel array.
   (15)

The solid-state imaging device according to (14), in which
the optical system includes:
a first optical system that condenses light on the first pixel array; and
a second optical system that condenses light on the second pixel array.
   (16)

The solid-state imaging device according to any one of (1) to (15), in which
the signal processing circuit includes:
a first signal processing circuit that performs signal processing on output from the first pixel; and
a second signal processing circuit that performs signal processing on output from the second pixel.
   (17)

The solid-state imaging device according to any one of (1) to (16), in which
the signal processing circuit
performs image processing on the basis of the image information subjected to the distortion correction and the event detection information subjected to the distortion correction.
   (18)

The solid-state imaging device according to (17), in which
the signal processing circuit
performs deblurring processing on the basis of the image information subjected to the distortion correction and the event detection information subjected to the distortion correction.
   (19)

The solid-state imaging device according to (17) or (18), in which
the signal processing circuit
performs high frame rate processing on the basis of the image information subjected to the distortion correction and the event detection information subjected to the distortion correction.
   (20)

The solid-state imaging device according to any one of (1) to (19), in which
the signal processing circuit
performs tracking processing on the basis of the image information subjected to the distortion correction and the event detection information subjected to the distortion correction.

Aspects of the present disclosure are not limited to embodiments described above, and include various kinds of conceivable modification. The effects of the present disclosure are also not limited to the content described above. The components in each of the embodiments may be appropriately combined and applied. That is, various kinds of addition, modification, and partial deletion can be made without departing from the conceptual idea and gist of the present disclosure derived from the content defined in the claims and equivalents thereof.

### REFERENCE SIGNS LIST

1 Solid-state imaging device
10 Optical system
12 Imaging section
120 Pixel array
121 First pixel
122 Second pixel
124 Horizontal driving circuit
126 Vertical driving circuit
128 Processing circuit
14 Storage section
16 Signal processing section
18 Input/output I/F
20 Chip
200 Pixel array region
202 Storage circuit region
204 Processing circuit region
31 First semiconductor layer
32 Second semiconductor layer
33 Third semiconductor layer

1. A solid-state imaging device comprising:
an optical system;
a first pixel that obtains image information based on luminance information via the optical system;
a second pixel that obtains event detection information based on a change in the luminance information via the optical system;
one or a plurality of pixel arrays in which the first pixels and the second pixels are provided in a two-dimensional array; and
a signal processing circuit that selects whether or not to perform distortion correction on the event detection information obtained by the second pixel and performs signal processing.

2. The solid-state imaging device according to claim 1, wherein
the one or plurality of pixel arrays includes one pixel array, and
the second pixels are arranged at a predetermined ratio with respect to the first pixels in a predetermined region in the pixel array.

3. The solid-state imaging device according to claim 2, wherein
the predetermined region includes an entire region of the pixel array.

4. The solid-state imaging device according to claim 2, wherein
the second pixels are arranged at equal intervals so as to cover an entire region of the predetermined region.

5. The solid-state imaging device according to claim 1, wherein
the second pixel detects an event for each frame.

6. The solid-state imaging device according to claim 1, wherein
the second pixel detects an event by an arbiter method.

7. The solid-state imaging device according to claim 1, wherein
the signal processing circuit performs distortion correction on the image information.

8. The solid-state imaging device according to claim 7, wherein
the signal processing circuit
converts resolution of the event detection information into resolution of the image information, and
performs distortion correction on the converted event detection information.

9. The solid-state imaging device according to claim 7, wherein
the signal processing circuit
performs the distortion correction on the event detection information based on a difference between resolution of the event detection information and resolution of the image information.

10. The solid-state imaging device according to claim 1, wherein
the signal processing circuit
sets a region of interest on a basis of the image information, and
obtains the event detection information corresponding to the region of interest.

11. The solid-state imaging device according to claim 10, wherein
the signal processing circuit
performs tracking on a basis of the event detection information subjected to the distortion correction corresponding to the region of interest.

12. The solid-state imaging device according to claim 1, wherein
the signal processing circuit
compares a value obtained by performing the distortion correction on the event detection information with a threshold for coordinates after performing the distortion correction on the event detection information, and obtains event detection information at the coordinates after performing the distortion correction.

13. The solid-state imaging device according to claim 12, wherein
the signal processing circuit
stores the event detection information at the coordinates after performing the distortion correction as 1.5 bit information.

14. The solid-state imaging device according to claim 1, wherein
the one or plurality of pixel arrays includes:
a first pixel array in which the first pixels are arranged in a two-dimensional array; and
a second pixel array in which the second pixels are arranged in a two-dimensional array and which obtains the event detection information of a same target as a target of the first pixel array.

15. The solid-state imaging device according to claim 14, wherein
the optical system includes:
a first optical system that condenses light on the first pixel array; and
a second optical system that condenses light on the second pixel array.

16. The solid-state imaging device according to claim 1, wherein
the signal processing circuit includes:
a first signal processing circuit that performs signal processing on output from the first pixel; and
a second signal processing circuit that performs signal processing on output from the second pixel.

17. The solid-state imaging device according to claim 1, wherein
the signal processing circuit
performs image processing on a basis of the image information subjected to the distortion correction and the event detection information subjected to the distortion correction.

18. The solid-state imaging device according to claim 17, wherein
the signal processing circuit
performs deblurring processing on a basis of the image information subjected to the distortion correction and the event detection information subjected to the distortion correction.

19. The solid-state imaging device according to claim 1, wherein
the signal processing circuit
performs tracking processing on a basis of the image information subjected to the distortion correction and the event detection information subjected to the distortion correction.
